(19) United States
(12) Patent Application Publication
(10) Pub. No.: US 2026/0251262 A1
(43) Pub. Date: Aug. 27, 2026

(54) MODULAR MOUNTING SYSTEM FOR MOUNTING AN ANIMAL SKULL

(71) Applicants: Joseph William Cavale, Phoenix, AZ (US); Dino Gotsis, Phoenix, AZ (US); Noah Gotsis, Phoenix, AZ (US)

(72) Inventors: Joseph William Cavale, Phoenix, AZ (US); Dino Gotsis, Phoenix, AZ (US); Noah Gotsis, Phoenix, AZ (US)

(21) Appl. No.: 19/546,987

(22) Filed: Feb. 23, 2026

Related U.S. Application Data
(60) Provisional application No. 63/762,297, filed on Feb. 24, 2025.

(51) Int. Cl. F16M 13/02; F16M 11/10

(52) U.S. Cl. CPC F16M 13/022; F16M 11/10

(57) ABSTRACT

A modular mounting system for mounting an animal skull to a wall, comprising a backer plate, a pivot joint, an elongated member, and a lock. The backer plate has a mounting stem protruding from its front side and is coupled to the wall on its back side. The elongated member, pivotally mounted to the pivot joint, has a flattened surface for receiving a removable tip and a notch for sliding into a foramen magnum of the animal's skull. The removable tip can be removably coupled to the flattened surface of the elongated member and is selectively detachable to accommodate varying skull geometries. The system also includes a retention member to selectively restrict and permit rotational movement, a support plate coupled to the elongated member, and a display fixed between the backer plate and the lock. The system allows for the secure and adjustable display of animal skulls.

### CROSS REFERENCE TO RELATED APPLICATIONS

This application claims benefit from currently pending U.S. Provisional Application No. 63/762,297 titled “Modular Mounting System for Mounting an Animal Skull” and having a filing date of Feb. 24, 2025, all of which is incorporated by reference herein.

### FIELD OF THE INVENTION

The present invention relates generally to taxidermy mounting systems, and more particularly to modular mounting systems for displaying European mounted animal skulls on walls.

### BACKGROUND OF THE INVENTION

European mount display of animal skulls, where the cleaned and whitened skull is mounted without the hide, has become increasingly popular among hunters and wildlife enthusiasts as a more minimalist and natural alternative to traditional shoulder mounts. However, mounting these delicate specimens presents unique challenges that conventional mounting systems have struggled to address effectively.

Existing European mount systems typically rely on basic wall brackets or simple plaques with fixed mounting points that fail to account for the intricate anatomical differences between species and individual specimens. These conventional mounting solutions often require drilling directly into the skull or using adhesives that can compromise the integrity of the bone structure. Furthermore, many current systems do not properly support the skull through the foramen magnum (the natural opening at the skull's base), which can lead to stress on delicate areas and potential damage over time.

Traditional European mount displays frequently employ rigid, non-adjustable mounting mechanisms that limit the ability to achieve optimal viewing angles. Once installed, these fixed systems provide little to no flexibility for adjusting the presentation angle or position of the skull. This inflexibility becomes particularly problematic when displaying multiple skulls in a collection or when relocating displays to different wall spaces.

Another significant limitation of current European mount systems is their inability to accommodate the wide range of skull sizes and anatomical variations across different species. From small deer to large elk, each skull presents unique mounting challenges due to variations in weight, balance points, and structural features. Existing mounting solutions often lack the versatility to safely and securely display this diverse range of specimens without requiring different mounting hardware for each type.

Additionally, many current mounting systems fail to provide adequate protection for the delicate structures of cleaned skulls, particularly around the occipital condyles and other vulnerable areas. The inability to distribute weight properly and secure the skull without excessive pressure points can lead to deterioration or damage of these valuable specimens over time. Furthermore, current mounting systems lack the ability to be attached to or integrated with a customizable plaque lacking the ability for the hunter to honor the uniqueness of their trophy through customized design elements.

These challenges underscore the need for an improved European mount system that can provide secure, adjustable mounting while preserving the natural integrity of the skull. Therefore, there is a need for a solution that combines modular components with anatomically-minded support mechanisms that would address many of the limitations inherent in traditional European mount display methods.

### SUMMARY OF THE INVENTION

The invention comprises a modular mounting system for mounting an animal skull to a wall. The system can include a backer plate having a front side and a back side, wherein a mounting stem can protrude from the front side and the back side can be configured to be coupled to the wall. The system can include a pivot joint in the mounting stem, wherein the pivot joint can have a pivot end and a connection end. The system can further include an elongated member having a proximal end and a distal end, wherein the proximal end can be pivotally mounted to the pivot end and the distal end can have a first flattened surface for receiving a removable tip. A lock can be coupled to the connection end of the pivot joint.

The elongated member can further comprise a notch shaped to slide into a foramen magnum of the skull, wherein the skull can have an occipital condyle, and the notch can retain the skull by a lower edge of the occipital condyles. The removable tip can comprise at least one serrated edge and can be removably coupled to the first flattened surface of the elongated member by a fastener. The removable tip can be one of a plurality of interchangeable tips selectable to accommodate anatomical geometries of varying skulls. The connection end can have a stem hole to which the mounting stem can be coupled. The lock can be configured to selectively restrict and permit rotational movement of the pivot joint and the elongated member, and the lock can be coupled between the connection end and the front side of the backer plate.

The elongated member can have a second flattened surface extending from the proximal end, wherein a support plate can be coupled to the second flattened surface by a fastener. The elongated member can be angled from the second flattened surface to the first flattened surface. The support plate can be shaped to clamp onto an occipital bone of the animal's skull. The support plate can further comprise at least one clamp fastener configured to clamp the animal skull between the support plate and the removable tip coupled to the first flattened surface of the elongated member.

The pivot joint and the elongated member can be pivotally mounted by a fastener that allows the elongated member to rotate to a set position. The elongated member can be selectively angled and positioned along the axis of the pivot joint and can be set and adjusted by a set screw. The mounting stem can be configured to allow rotational movement of the pivot joint and the elongated member about an axis of the mounting stem, thereby permitting axial positioning of the animal skull at a user-selected rotational position.

The system can further comprise a display fixed between the backer plate and the lock by a display nut, and the display can be a plaque or any other suitable display item. The backer plate can further comprise at least one mounting hole configured to couple the back side of the backer plate to the wall. The pivot end of the pivot joint can further comprise a pivot cavity that can define stop limits restricting a range of rotational movement of the elongated member relative to the pivot joint. The pivot end can further comprise a mounting boss configured to receive a threaded fastener to pivotally couple the elongated member to the pivot joint. The connection end of the pivot joint can further comprise a partially threaded portion, and the lock can be threadably engaged with the partially threaded portion to secure the pivot joint in position against the backer plate.

The notch can further comprise a notch protrusion extending from the notch toward the bottom of the elongated member. The modular mounting system can provide a versatile and adjustable means of displaying animal skulls, combining security, adjustability, and versatility to create an effective system for displaying mounted animal skulls on a wall or other vertical surface.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors'intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of ...”), without also reciting in such phrases any structure, material or act in support of the function. Thus, even when the claims recite a “means for performing the function of. “or” step for performing the function of. ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF DRAWINGS

A more complete understanding of the present invention may be derived by referring to the detailed description when considered in connection with the following illustrative figures. In the figures, like reference numbers refer to like elements or acts throughout the figures.

FIG. 1 shows an isometric view of the modular mounting system in accordance to one or more embodiments;

FIG. 2a shows a front view of the modular mounting system in accordance to one or more embodiments;

FIG. 2b shows a cross-sectional view of the modular mounting system in accordance to one or more embodiments;

FIG. 3a shows a right side view of the modular mounting system in accordance to one or more embodiments;

FIG. 3b shows a right side view angled up of the modular mounting system in accordance to one or more embodiments;

FIG. 4 shows a top view of the modular mounting system in accordance to one or more embodiments;

FIG. 5 shows a bottom view of the modular mounting system in accordance to one or more embodiments;

FIG. 6 shows a left side view of the modular mounting system in accordance to one or more embodiments;

FIG. 7 shows a bottom isometric view of the modular mounting system in accordance to one or more embodiments;

FIG. 8 shows an exploded isometric view of the modular mounting system in accordance to one or more embodiments;

FIG. 9 shows an exploded side view of the modular mounting system in accordance to one or more embodiments;

FIG. 10 shows an exploded side view of the modular mounting system with a sample plaque in accordance to one or more embodiments;

FIG. 11 shows isometric view of the modular mounting system attached to the skull of an animal in accordance to one or more embodiments; and

FIG. 12 shows bottom isometric view of the modular mounting system attached to the skull of an animal in accordance to one or more embodiments.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention. It should be noted that there are many different and alternative configurations, devices, and technologies to which the disclosed inventions may be applied. The full scope of the inventions is not limited to the examples that are described below.

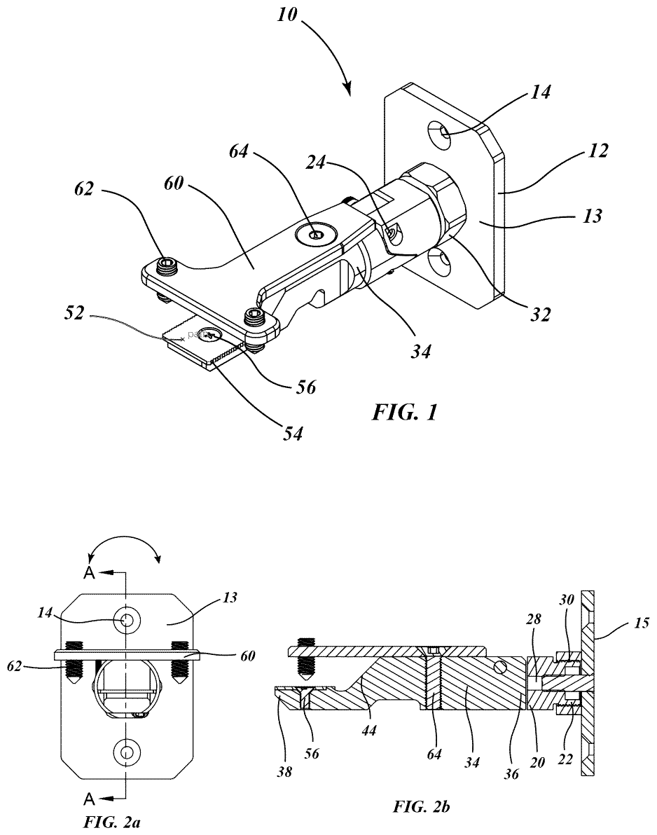

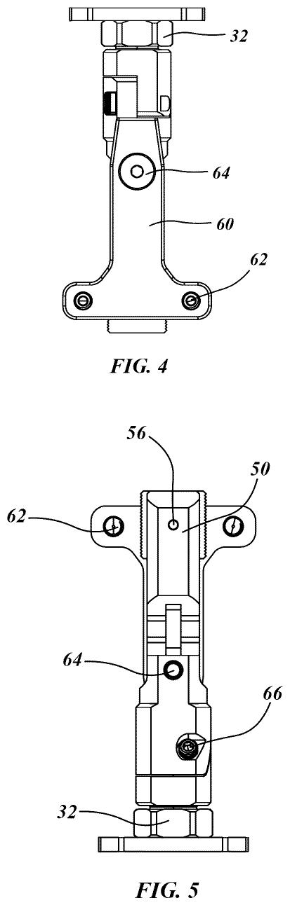

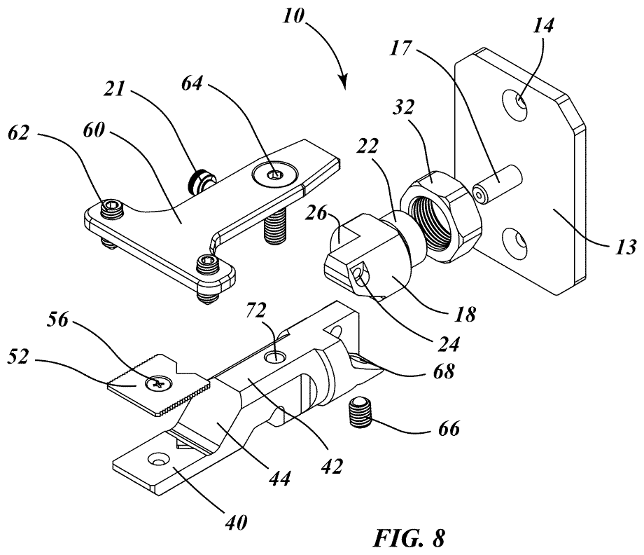

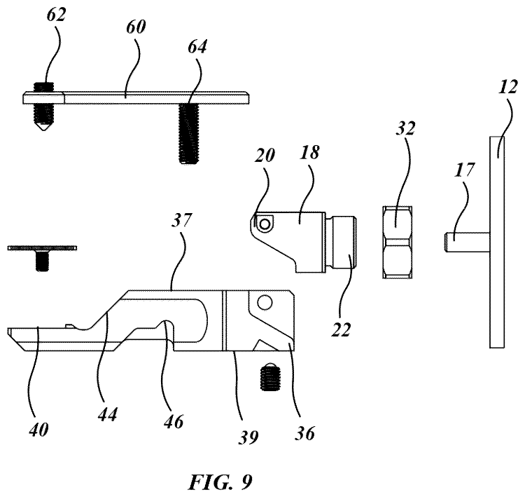

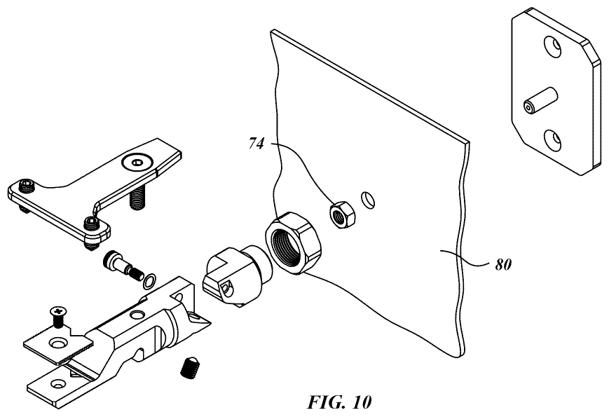

Referring initially to FIG. 1-12 a modular mounting system for mounting an animal skull 100 such as a European mount to a wall is shown generally at 10. The modular mounting system can comprise a backer plate 12, having a front side 13 and a back side 15, with a mounting stem 17 protruding from the front side. The back side 15 can be coupled to the wall. The backer plate 12 can include at least one mounting hole 14, wherein the mounting holes can be positioned at opposing locations along the upper and lower edges of the backer plate. Alternatively, the mounting holes can be arranged as diagonal pairs, symmetrically spaced apertures, a series of evenly distributed holes along the perimeter, clusters of holes at strategic mounting points, elongated slots for adjustable positioning, keyhole-shaped openings for quick mounting and removal, countersunk holes for flush mounting, reinforced through-holes with integrated bosses, threaded inserts for direct fastener engagement, or any combinations thereof.

In certain embodiments, the backer plate 12 can include at least one mounting hole 14 configured to couple the back side 15 of the backer plate to the wall. In the preferred embodiment, the mounting holes 14 can be positioned at opposing locations along the upper and lower edges of the backer plate 12 to provide balanced load distribution when the modular mounting system 10 is secured to the wall. The mounting holes 14 can be sized and shaped to receive conventional wall fasteners such as, for example, wood screws, lag bolts, toggle bolts, or the like, depending on the wall substrate encountered. The placement of the mounting holes 14 at opposing locations can allow the user to level the backer plate 12 during installation and can provide resistance to rotational loads imparted by the weight of the animal skull 100 and any coupled display 80.

In embodiments, the mounting stem 17 can protrude from the front side 13, wherein the mounting stem can be configured as such as, for example, a shaft, a threaded shaft, a dovetail projection, a keyed shaft, a quick-release mechanism, a spring-loaded pin, a tapered shaft, a friction-fit stem, or the like. The mounting stem 17 can be secured to the backer plate 12 such as, for example its front side 13, back side 15 or the like using one or more attachment methods including such as, for example, pinning, welding, adhesive bonding, threading, press fitting, or the like. In other embodiments, the mounting stem 17 can include a hollow shaft for routing utilities, a D-shaped cross-section for anti-rotation, a telescoping mechanism for adjustable extension, or an articulating joint for variable positioning. The attachment method can further incorporate mechanical interlocking features, structural reinforcement, or sealing elements to enhance the connection integrity. The mounting stem 17 can allow the user to rotate the modular mounting system 10 around its axis as shown in FIG. 2a thus allowing the user to axially position the skull at the desired position.

In certain embodiments, the mounting stem 17 can allow the user to rotate the modular mounting system 10, including the pivot joint 18 and the elongated member 34, around the axis of the mounting stem as shown in FIG. 2a, thus allowing the user to axially position the animal skull 100 at a desired rotational position. This axial rotation capability can be particularly useful when the animal skull 100 has asymmetrical antler configurations or uneven weight distribution, allowing the user to reposition the skull to achieve an aesthetically balanced presentation without removing the backer plate 12 from the wall. The mounting stem 17 can be configured to allow free rotation until the lock 32 is tightened to secure the pivot joint 18 at the user-selected rotational position, providing a simple one-step adjustment mechanism.

In embodiments, the mounting system 10 can have a pivot joint 18, having a pivot end 20 and a connection end 22. The pivot end 20 can have a mounting boss 24 configured to receive a threaded fastener, wherein the mounting boss can be integrally formed with the pivot joint 18. The pivot end can further comprise a pivot cavity 26. The pivot cavity 26 can be such as, for example, a tapered relief cut, radiused cut, chamfered cut, or the like and can have stop limits machined within the pivot cavity limiting the rotation of the joint. The pivot cavity 26 can be such as, for example, semi-circular, V-shaped, rectangular, compound path, progressive path, or the like. The connection end 22 can include a stem hole 28 configured to receive and be coupled to the mounting stem 17, wherein the stem hole can be formed with various features such as smooth bores, keyways, splines, or combinations thereof.

In certain embodiments, the mounting boss 24 can be integrally formed with the pivot joint 18 at the pivot end 20 and can be configured to receive a threaded fastener 21 such as, for example, a shoulder screw or socket head cap screw, to pivotally couple the proximal end 36 of the elongated member 34 to the pivot end 20. The integral formation of the mounting boss 24 can provide a reinforced bearing surface that resists wear during repeated angular adjustments of the elongated member 34. The pivot cavity 26 formed at the pivot end 20 can have stop limits machined within the pivot cavity that restrict the range of rotational movement of the elongated member 34 relative to the pivot joint 18, thereby preventing over-rotation that could cause the animal skull 100 to contact the backer plate 12 or the wall surface. The stop limits can be configured to allow a range of angular adjustment sufficient to accommodate the typical range of display angles desired by users, such as, for example, a level position, a downward-angled position simulating a natural head carriage, or an upward-angled position for elevated display installations.

In embodiments the connection end 22 can further comprise a partially threaded portion 30, wherein the threaded portion can be configured with male threads, thread locking features, anti-rotation elements, or combinations thereof. The partially threaded portion can alternatively include tapered threads, fine threads, coarse threads, interrupted threads, modified thread forms, or specialized thread profiles for enhanced engagement. A lock 32 can be threadably engaged with the partially threaded portion 30 to secure the pivot joint 18 in position against the backer plate 12. The stem hole 28 can alternatively be configured with features such as internal splines, keyways, anti-rotation flats, retention grooves, thread locking elements, torque-limiting features, clearance zones for fastener engagement, depth-limiting shoulders, or combinations thereof. The lock 32 can incorporate various locking mechanisms such as nylon inserts, deformed threads, spring washers, castellated features, cotter pin provisions, or prevailing torque elements to maintain the secured position.

In certain embodiments, the partially threaded portion 30 of the connection end 22 can extend a sufficient axial distance to allow the lock 32 to be threaded forward and rearward along the partially threaded portion, thereby adjusting the compressive force applied against the display 80 and the backer plate 12. When the lock 32 is tightened against the backer plate 12, the compressive engagement between the lock 32, the display 80, the backer plate 12, and the connection end 22 can create a rigid, non-rotating assembly that fixes the angular position of the modular mounting system 10 about the axis of the mounting stem 17. When the lock 32 is loosened, the pivot joint 18 can be freely rotated about the mounting stem 17 to reposition the animal skull 100, after which the lock 32 can be re-tightened to secure the new position.

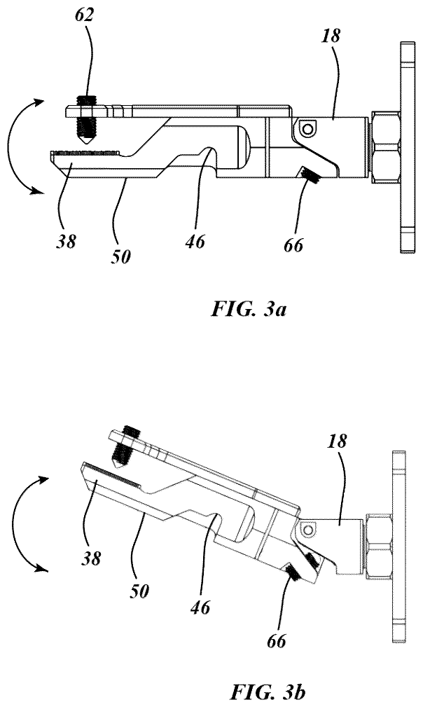

In embodiments, an elongated member 34, can have a proximal end 36 and a distal end 38, and a top 37 and a bottom 39 wherein the proximal end can be pivotally coupled to the pivot end 20 of the pivot joint 18, wherein the proximal end 36 can be configured with complementary features that correspond to the pivot end 20 and pivot cavity 26. The pivot joint 18 and the elongated member 34 can be pivotally coupled together by a fastener 21 such as, for example, a shoulder screw, set screw, bearing joint, socket head cap screw allowing the elongate member to rotate to a user's preferred position, as shown in FIG. 3. The pivot joint 18 and the elongate member 34 can be set at a user's desired angle by a set screw 66, which can be such as, for example, a set screw, hex socket screw, flat head screw, carriage bolts, thumb screw, or the like.

The set screw 66 can be configured to operatively couple with the bottom 39 of the elongated member 34 through a set screw hole 68, wherein the set screw enables variable positional adjustment through direct engagement with the elongated member. This configuration facilitates user-selected angular orientations of the animal's skull through adjustable pressure application. Specifically, the set screw's threading allows for precise incremental adjustments, whereby tightening or loosening the set screw modifies the point of contact against the elongated member 34, thus securing the desired angular position. The mechanical interface between the set screw 66 and the elongated member 34 can create a stable, adjustable pivot point that can be readily modified to accommodate different skull positioning requirements wherein the set screw can push against pivot joint 18 acting as a point of contact when the user selectively sets the elongated member to the desired position. When the optimal angle is achieved, the set screw 66 can maintain the selected position, providing a secure and stable mounting arrangement for the animal's skull. The design inherently allows for subsequent adjustments by simply rotating the set screw 66, modifying the angle to the desired position.

In certain embodiments, the set screw hole 68 can be formed through the bottom 39 of the elongated member 34 at a position between the proximal end 36 and the angled section 44, wherein the set screw hole can be threaded to engage the set screw 66. The location of the set screw hole 68 can be selected to provide a mechanical advantage when the set screw 66 bears against the pivot joint 18, maximizing the angular holding force achievable with a given torque applied to the set screw. In certain embodiments, a plurality of set screw holes 68 can be provided at different positions along the bottom 39 of the elongated member 34, allowing the user to select among discrete angular adjustment positions by relocating the set screw 66 to a different set screw hole.

In embodiments, the proximal end 36 and the pivot joint 18 can have complimentary mating features such as, for example, matching pivot surfaces, alignment features, bearing surfaces, clearance zones, anti-rotation elements, or the like, or any combinations thereof. The proximal end 36 can alternatively be configured with various profiles such as rounded surfaces, flat surfaces, tapered sections, reinforced regions, wear-resistant elements, or combinations thereof to facilitate pivotal movement within the pivot cavity 26. The lock 32 can be configured to selectively restrict and permit rotational movement of the elongated member 34 effectively allowing for adjustment around the axis of the skull. The lock 32 can be coupled between the connection end 22 and the front side of the backer plate 13.

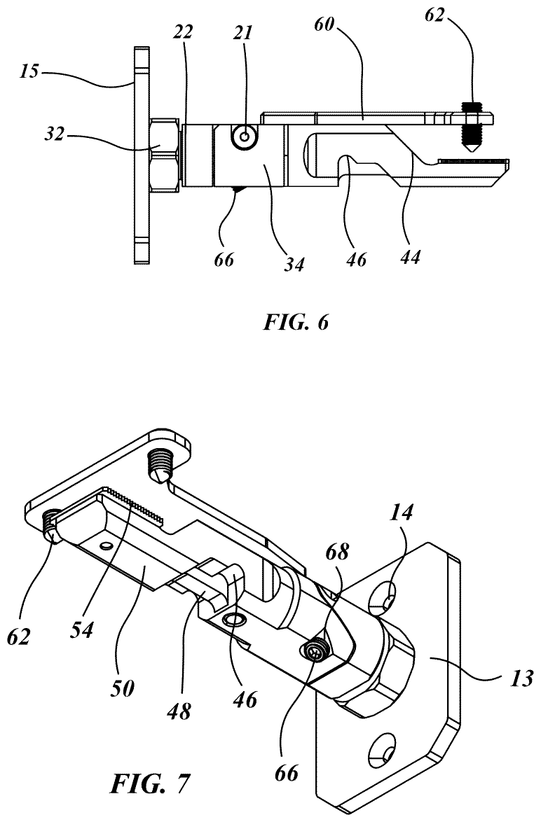

On the top 37 of the elongate member 34, the distal end 38 can have a first flattened surface 40 for receiving a removable tip 52. The elongated member 34 can have a second flattened surface 42 that extends from the proximal end 36 to an angled section 44 which can extend to the first flattened surface 40 which extends to the distal end 38. On the bottom 39 the elongated member 34 can further comprise a notch 46 that can be on at least one side of the elongated member wherein the elongated member can slide into a foramen magnum of the animal's skull and retains the skull by a lower edge of occipital condyles 104 by the notch, as shown in FIG. 12, but in other embodiments can retain the skull by other skull edges or holes. The notch 46 can be any suitable shape and size, but in the preferred embodiment the notch can be shaped as shown in FIGS. 6 and 7. The notch 46 can extend to a bottom surface 50 which can extend to the distal end 38. A notch protrusion 48 can extend from the notch to substantially near the bottom 39 as shown in FIG. 7 and in other embodiments, the notch protrusion can be omitted. In other embodiments, the notch can either be omitted or can be sized to different size animal skulls so that the notch can fit into skulls such as, for example, mule deer, elk, coues deer, white-tail deer, javelina, boar, or any other hunted animal that hunter's mount on their walls in the European mount fashion.

The removable tip 52 can be removably coupled to the first flattened surface 40 of the elongated member 34 by at least one tip fastener 56. The removable tip 52 can have at least one serrated edge 54 on at least one of its edges wherein serrated edge can be such as, for example, saw-like teeth, wave patterns, angular notches, or the like or in other embodiments the serrated edge can be omitted, or it can be a smooth or waved edge. The removable tip 52 can be selectively detachable to accommodate anatomical geometries of varying skulls. The removable tip 52 can be sized and shaped to accommodate varying anatomical geometries of internal surface of the occipital bone and of varying skulls. In certain embodiments, the removable tip 52 can be permanently removed or permanently coupled by such as, for example, at least one tip fastener 56, weld, adhesive, solder, or the like.

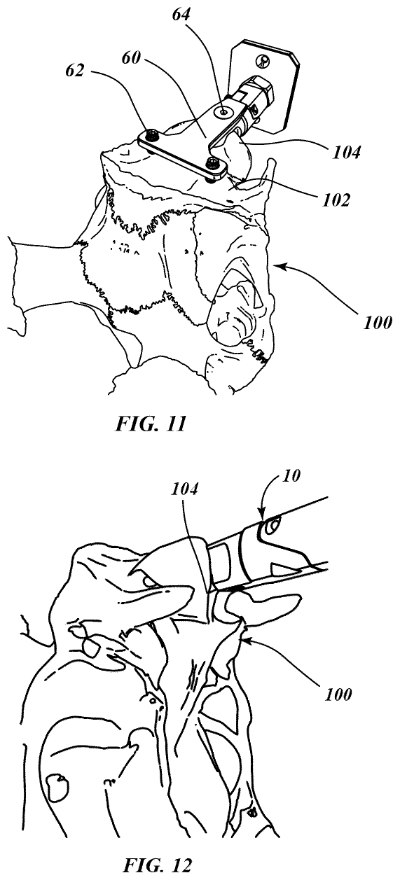

The second flattened surface 42 can extend from the proximal end the angle section 44 wherein the second flattened surface can have a support hole 72 wherein the support plate 60 can be coupled to the second flattened surface by at least one support fastener 64 through the support hole wherein the support fastener can be such as, for example, flat head screws, socket head cap screws, thumb screws, hex screws, or the like. The support plate 60 can clamp onto the animal's skull such as, for example, the skulls squamous occipital 102, squamous part of the occipital bone or the like, as shown in FIG. 11. The support plate 60 can be any suitable size and shape but in the preferred embodiment the shape can be, as shown in FIG. 1, like such as, for example, T-shape, straight, V-shape, or any suitable shape that can be clamped onto an animal's skull of varying size and shapes. The support plate 60 can have at least one clamp fastener 62 that can be fastened into or can be clamped down on the animal's skull wherein the skull can be clamped between the support plate and the removable tip 52 which can be attached to the first flattened surface 40. The support plate 60 can lock the skull in place and can add security and can aid in mounting the skull with asymmetrical weight distribution due to varying antler sizes or any other anatomical weight incongruencies, and in other embodiments, the support plate can be omitted by the user.

In certain embodiments, the support plate 60 and the removable tip 52 can function together as a clamping assembly wherein the animal skull 100 can received between the support plate 60 bearing against the squamous occipital 102 and the removable tip 52 bearing against the internal surface of the occipital bone. The at least one clamp fastener 62 of the support plate 60 can be advanced to apply compressive force against the animal skull 100, drawing the skull upward against the removable tip 52 to create a secure, positive retention of the skull on the elongated member 34. This clamping engagement can be particularly advantageous when the animal skull 100 has anatomical features that reduce the engagement between the notch 46 and the occipital condyles 104, such as, for example, skulls with worn or atypical condyle geometry. The combination of the notch 46 engaging the occipital condyles 104 and the clamping action of the support plate 60 against the removable tip 52 can provide redundant retention mechanisms that distribute the load of the animal skull 100 across multiple contact points, reducing stress concentration on any single anatomical feature of the skull.

In certain embodiments, a display 80 can be fixed between the backer plate and the lock 32 by a display nut 74. The display 80 can be a plaque or any other suitable display item. This modular mounting system provides a versatile and adjustable means of displaying an animal skull on a wall or other vertical surface. The display nut 74 can be configured as a decorative fastener such as, for example, a hex nut, a knurled nut, a wing nut, a cap nut, or any other suitable fastener that can provide both mechanical clamping force and an aesthetically finished appearance on the front side of the display 80. The display nut 74 can be threadably engaged with the partially threaded portion 30 of the connection end 22 on the side of the display 80 opposite the backer plate 12, creating a sandwich engagement that retains the display 80 securely in the interstitial space between the backer plate 12 and the display nut 74. A user can remove the display 80 and replace it with a different display without disturbing the mounting of the backer plate 12 to the wall, providing a convenient mechanism for updating or personalizing the display over time.

The display 80 can be configured to be securely mounted in the interstitial space between the backer plate 12 and the lock 32 through mechanical fastening. The display nut 74 provides compressive force to maintain the display element's position while allowing for removal and replacement as needed. The display 80 can comprise various presentation media, including but not limited to, a commemorative plaque, an identification plate, a decorative panel, an informational signage unit, or any other suitable display article that enhances the aesthetic or informative qualities of the assembly. The configuration of this mounting system 10 enables the display 80 to be prominently featured while maintaining structural integrity through the mechanical interaction of the backer plate 12, lock 32, and display nut 74 components. This arrangement facilitates both secure mounting and visual accessibility of the display element, while the versatility of acceptable display items allows for customization according to the end user's preferences or requirements. The assembly method ensures that the display remains stable during normal use while providing the capability for future modifications or replacements of the display component.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

We claim:

1. A modular mounting system for mounting an animal skull to a wall, comprising:
a backer plate having front side and a back side wherein a mounting stem protrudes from the front side and the back side is configured to be coupled to the wall;
a pivot joint in the mounting stem, the pivot joint having a pivot end and a connection end;
an elongated member having a proximal end and a distal end wherein the proximal end is pivotally mounted to the pivot end and the distal end having a first flattened surface for receiving a removable tip; and
a lock coupled to the connection end of the pivot joint.

2. The modular mounting system of claim 1, wherein the elongated member further comprises a notch shaped to slide into a foramen magnum of the skull having an occipital condyle to retain the skull by a lower edge of occipital condyles.

3. The modular mounting system of claim 1, wherein the removable tip comprises at least one serrated edge and is removably coupled to the first flattened surface of the elongated member by a fastener.

4. The modular mounting system of claim 3, wherein the removable tip is one of a plurality of interchangeable tips selectable to accommodate anatomical geometries of varying skulls.

5. The modular mounting system of claim 1, wherein the connection end has a stem hole to which the mounting stem is coupled.

6. The modular mounting system of claim 5, wherein the lock is configured to selectively restrict and permit rotational movement wherein the lock is coupled between the connection end and the front side of the backer plate.

7. The modular mounting system of claim 1, wherein the elongated member has a second flattened surface extending from the proximal end wherein a support plate is coupled to the second flattened surface by a fastener.

8. The modular mounting system of claim 7, wherein the elongated member is angled from the second flattened surface to the first flattened surface.

9. The modular mounting system of claim 7, wherein the support plate is shaped to clamp onto an occipital bone of the animal's skull.

10. The modular mounting system of claim 1, wherein the pivot joint and the elongated member are pivotally mounted by a fastener that allows the elongated member to rotate to a set position.

11. The modular mounting system of claim 1, wherein the elongated member is selectively angled and positioned along the axis of the pivot joint and is set and/or adjusted by a set screw.

12. The modular mounting system of claim 1, further comprising a display fixed between the backer plate and the lock by a display nut.

13. The modular mounting system of claim 12, wherein the display is a plaque.

14. The modular mounting system of claim 1, wherein the backer plate further comprises at least one mounting hole configured to couple the back side of the backer plate to the wall.

15. The modular mounting system of claim 1, wherein the pivot end of the pivot joint further comprises a pivot cavity that defines stop limits restricting a range of rotational movement of the elongated member relative to the pivot joint.

16. The modular mounting system of claim 1, wherein the connection end of the pivot joint further comprises a partially threaded portion, and wherein the lock is threadably engaged with the partially threaded portion to secure the pivot joint in position against the backer plate.

17. The modular mounting system of claim 1, wherein the mounting stem is configured to allow rotational movement of the pivot joint and the elongated member about an axis of the mounting stem, thereby permitting axial positioning of the animal skull at a user-selected rotational position.

18. The modular mounting system of claim 7, wherein the support plate further comprises at least one clamp fastener configured to clamp the animal skull between the support plate and the removable tip coupled to the first flattened surface of the elongated member.

19. The modular mounting system of claim 2, wherein the notch further comprises a notch protrusion extending from the notch toward the bottom of the elongated member.

20. The modular mounting system of claim 1, wherein the pivot end of the pivot joint further comprises a mounting boss configured to receive a threaded fastener to pivotally couple the elongated member to the pivot joint.
